(19) United States
(12) Patent Application Publication
(10) Pub. No.: US 2005/0075172 A1
(43) Pub. Date: Apr. 7, 2005

(54) Cover for a video game controller

(76) Inventor: Jourdon G. S. Coleman, Honolulu, HI (US)

Correspondence Address: Garrison & Associates PS;William L. Haynes, Suite 3300, 2001 Sixth Avenue, Seattle, WA, 98121-2522, US

(21) Appl. No.: 10/958,474

(22) Filed: Oct. 4, 2004

Related U.S. Application Data
(60) Provisional application No. 60/508,408, filed on Oct. 2, 2003.

(51) Int. Cl. A63F 13/00

(52) U.S. Cl. 463/47

(57) ABSTRACT

A cover for customizing and providing improved comfort and feel of a hand-held video game controller. The controller cover is an easily attachable and removable soft cover made of cloth, vinyl, leather, or the like, configured to conform to the size and shape of particular models of video game controllers. Openings in the surface of the cover allow for ready access to control actuators. In a preferred embodiment, the cover is provided with padded material such as neoprene or other compressible foam in proximity to the game controller handles, and the cover is ergonomically padded to provide an improved grip, improved gaming performance and a minimization of hand muscle fatigue even during a protracted period of continuous use.

### TECHNICAL FIELD

This invention relates generally to hand controllers as used for playing video games and performing simulations on personal computers and dedicated video game systems, and more particularly to a textured and padded covering for use on video game controllers, the cover having unique tactile properties that enhance the ergonomics and appearance of the device.

### BACKGROUND OF THE INVENTION

Various controllers and simulation devices have been developed which attempt to satisfy an operator's desires for realistic control, comfortable use, quick response, accurate input transfer and ease of button/function access. These devices include: single-handed controllers, analog controllers, digital controllers, two-handed controllers, joystick controllers, throttle devices, steering wheel inputs, gun-shaped controllers, foot controllers, and much more; each of them striving to meet consumer demands for a more enjoyable gaming experience. The vast majority of video game controllers developed are in the form of two-handed controllers, which provide more broadly applicable use on a wide variety of video games. Even with all these devices, however, there still remain several industry-wide problems.

Conventional controllers lack a comfortable, ergonomic gripping structure configured for various hand-sizes, which is desirable for both normal and extended use. In order to be comfortable and ergonomic, the gripping structure should “fill” the user's hands, regardless of size. The need exists, therefore, for a controller that provides a comfortable and ergonomic gripping structure for use by operators with various hand-sizes.

The ever-increasing popularity of video games has resulted in a multitude of game controller designs and models. The video games themselves have dramatically improved in terms of complexity of play and the ability to occupy game players for hours at a time. Previous game controller designs have provided various shaped controller grips to more readily accommodate the hands of a user, but have not addressed the need for minimization of hand fatigue and prevention of repetitive motion injury that can occur with protracted periods of continuous use. The surface texture of the grips of typical game controllers is a hard plastic with at most a slightly raised or indented pattern intended to improve grip. As a player's hands fatigue or begin to perspire with extended play, these surfaces lose their ability to provide a sufficient grip. There remains a need for providing a more comfortable surface texture that can be gripped by a user that would minimize hand muscle fatigue and repetitive motion injury during protracted periods of continuous use.

Also, where a controller is likely to be subject to shock, such as being dropped on a hard surface, or exposed to liquids or a wet environment, there remains a need for a surface that protects the controller from damage.

Many video game controllers are available with a wide variety of operational and visual features. These visual features are, for the most part, directly related to operational features (e.g., switch colors, LEDs and other visual indicators), and do not address the potential for customizing the appearance of a controller. There remains a need for a user to customize the appearance and feel of a particular controller based on personal aesthetic preferences or for improved gaming performance.

The prior art teaches covers for computer peripheral accessory devices, particularly keyboards, for purposes of protection and customized performance.

U.S. Pat. No. 5,551,497 discloses a decorative two-part cover assembly for computer keyboards, comprising a body covering portion and a key covering portion. The body-covering portion may be held in place by elastic banding and/or hook and loop fastening strips. The key covering portion may be held in place by hook and loop fastening strips. The cover assembly material may be a textile fabric, leather, vinyl, or the like.

U.S. Pat. No. 6,285,299 discloses a soft cover adapter for customizing and/or simplifying the use of a computer keyboard comprised of an easily attachable soft cover made of cloth, vinyl, leather, or the like, configured in size and shape to cover a computer keyboard.

U.S. Pat. No. 6,612,432 B2 discloses a universal case for holding a portable electronic device that can be adjusted to accommodate a wide variety of portable electronic devices such as palm pilots, personal digital assistants, and in particular, cellular telephones.

These disclosures specifically teach coverings for electronic devices without addressing the needs of improved ergonomics and a user's improved performance therefrom.

More recent developments in the growing computer and video game industry have addressed concerns for ergonomic designs for improved user comfort and handling.

U.S. Pat. No. 6,288,709 discloses a hand-held data entry system having an ergonomic housing to allow a user two-handed control of multiple actuators located on the upper surface of the apparatus.

U.S. Pat. No. 5,923,317 discloses a two-handed game controller having, in addition to its operational features, a physical form with semicircular sides and 3-dimensionally tapered hand-grips, facilitating grip from virtually any size hand, from child to adult that is intended to provide a comfortable and ergonomic gripping structure that fills the user's hands, regardless of their size, for both normal and extended game play.

While these disclosures teach ergonomic structures for controller housings that create a more comfortable hand-held form, they do not teach soft or padded gripping textures that would minimize hand muscle fatigue and repetitive motion injury during protracted periods of continuous use, nor do they teach the use of graphic indicia to customize the appearance of a controller.

### SUMMARY OF THE INVENTION

It is an object of this invention to provide a cover accessory for a video controller that has an ergonomically padded grip surface for improved comfort and feel, thereby providing improved performance.

It is another object of this invention to provide an ergonomic and decorative video game controller cover having a padded grip surface providing improved comfort and feel of a hand-held video game controller, thereby providing improved gaming performance.

It is a further object of this invention to provide a cover that is easily and conveniently attachable to a controller to modify or customize its use for specific users and applications, and which also may be conveniently removed to return the controller to its standard or conventional mode of use.

It is an object of this invention to provide an attachable and detachable ergonomic and decorative video game controller cover for customizing and providing personalized appearance and feel of a hand-held video game controller.

Disclosed herein is a flexible soft cover configured in size and shape to conform to the size and shape of particular models of existing video game controllers. In at least one preferred embodiment of the invention, the cover adsorbs perspiration from the user's hands. One preferred embodiment of the cover disclosed herein is constructed from faux suede but for other embodiments the flexible cover material may be selected from a variety of materials including, for example, a textile fabric, leather, a polymeric material such as vinyl, polyurethane, etc., or other similar material. At least one preferred embodiment of the invention is machine washable.

The cover is glove-like in that it has an inner surface, an outer surface, and an interior cavity that is conformable to the shape of a video controller device. The cover has an opening for insertion of a video controller into the inner cavity. The controller can be secured in the cavity using a variety of means, and at least one preferred embodiment uses elastic loops, that are located on the outside of the cover, to secure a controller inside of a cover.

Additional openings in the surface of the cover allow for ready access to control actuators and are located such that there is no interference with hand and finger movement. Game play is actually enhanced by providing a more reliable grip on the handle(s) of a controller, thereby reducing hand muscle fatigue. The openings may be tapered or faired to the adjacent surface for free access to the controls.

In some embodiment, the cover is made from two overlapping layers of soft flexible material and at least one preferred embodiment has a layer of faux suede that defines the outer surface of the cover and a layer of vinyl that defines the inner surface of the cover. In at least one preferred embodiment, the inside of the cover is provided with padded material such as neoprene or other compressible foam in between the inside surface and the outside surface in proximity to the game controller handles. Thus the cover is ergonomically padded to provide an improved grip, improved gaming performance and a minimization of hand muscle fatigue even during a protracted period of continuous use.

The compressible padding may be in the form of several individual pads, or larger continuous padding conforming to the shape of the video game controller hand grips and in another preferred embodiment, the cover may be constructed from a single layer of material and the padding may be attached to the inner surface of the cover material. In at least one other preferred embodiment, the cover is made from soft flexible material having sufficient compressible properties to cushion a user's hand without the need of two layers of material that have padding placed between the layers. Alternatively, padding may be affixed directly to the surface of the controller and thereafter covered with the cover apparatus.

Optional decorative logos or insignia may be attached to or integral to the outer surface of the cover. The insignia, logos, or other markings may be in the form of photos, drawings, or other design images or graphics. Such designs would allow for customization and enhanced aesthetic appeal of a user's game controller.

The foregoing and other objects, features and advantages of the invention will become more readily apparent from the following detailed description of a preferred embodiment of the invention, which proceeds with reference to the accompanying drawings.

### BRIEF DESCRIPTION OF THE DRAWINGS

The objects and features disclosed herein, which are believed to be novel, are set forth in the appended claims. The present invention, both as to its organization and manner of operation, together with further objects and advantages, may best be understood by reference to the following descriptions, taken in conjunction with the accompanying drawings wherein:

FIG. 1 shows a perspective view, from above, of a video game controller inserted into a cover of the type disclosed herein.

FIG. 2A shows an elevation view of the back of a video game inserted into a cover of the type disclosed herein.

FIG. 2B shows a partial cross-sectional view of the back of a video game controller inserted into a cover of the type disclosed herein.

FIG. 3A shows a side elevation view of a video game controller inserted into a cover of the type disclosed herein.

FIG. 3B shows a partial cross-sectional of the left side of a video game controller inserted into a cover of the type disclosed herein.

FIG. 4A shows an elevation view of the front side of a video game controller inserted into a cover of the type disclosed herein.

FIG. 4 shows a partial cross-sectional view of the front side of a video game controller inserted into a cover of the type disclosed herein.

FIG. 5 shows a bottom plan view of a video game controller inserted into a cover of the type disclosed herein.

### DETAILED DESCRIPTION OF THE INVENTION

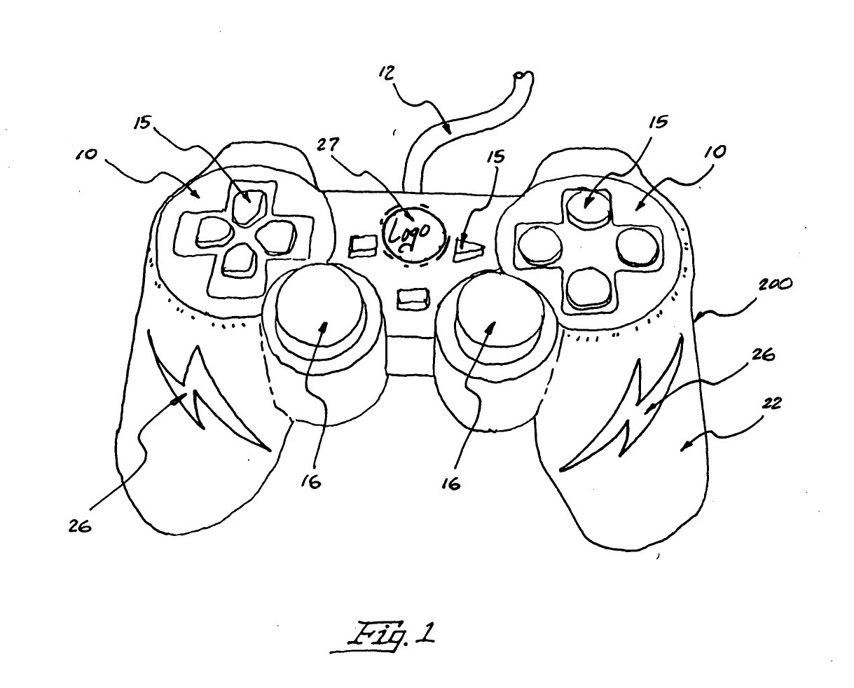

Turning now to the drawings, the invention will be described in a preferred embodiment by reference to the numerals of the drawings wherein like numbers indicate like parts. Referring to FIGS. 1 through 5, the current invention is a textured, padded cover for a video game controller. The following description emphasizes the structural aspects of the padded cover as used for video game controllers.

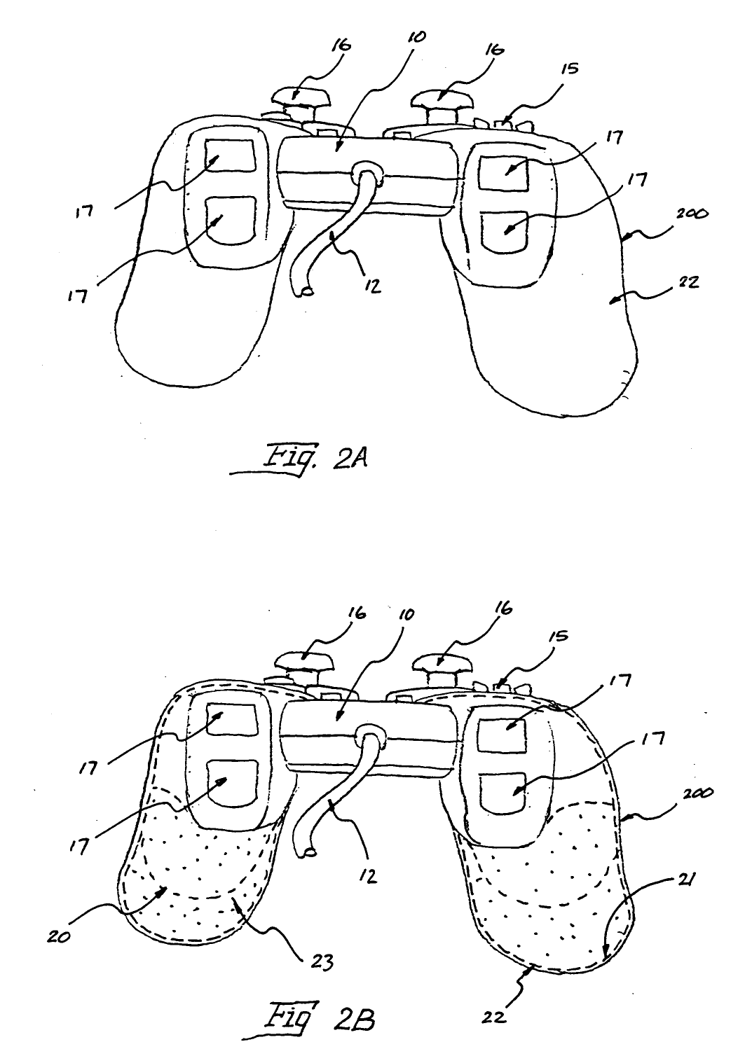

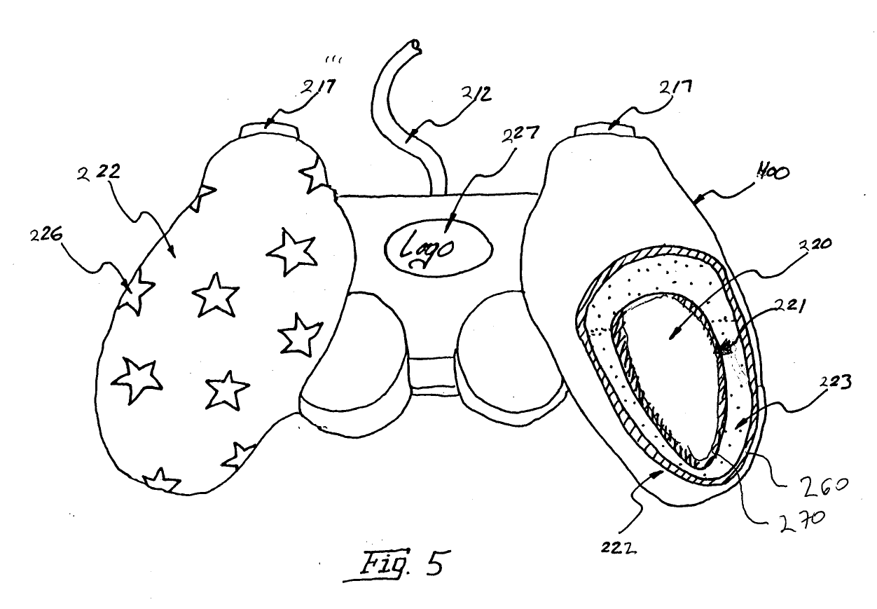

FIG. 1 shows a two-handed video game controller packaged with an ergonomic housing having an upper surface 10 through which a plurality of actuators extend for operation by a user's fingers. The relative positions of actuators are shown on the top structure of a typical game controller. Actuators may include push buttons 15, x-y joystick directional devices 16 and other touch-sensitive surfaces. Additional or redundant actuators 17 may be positioned along the back side edge, FIG. 2A, or underside of the controller body, FIG. 5, to provide auxiliary gaming functions or optional hand positioning for the user.

As represented in FIGS. 1-5, the housing and gripping members and are configured such that the controller will comfortably fit virtually any user's hands, regardless of hand size. Gripping members are tapered downward and outward, narrowing toward the front of the housing, such that they will fill the user's hands comfortably when he/she positions them at an appropriate spot along the grips, as determined by hand size.

The padded cover of a preferred embodiment essentially includes a glove-like body portion, as shown in FIG. 2A, 200 having an inner surface 21 and an outer surface 22 and is configured to conform exactly to the 3-dimensional volumetric form of a controller housing 20. The cover material may be selected from a variety of flexible materials including, for example, a textile fabric, leather, a polymeric material such as vinyl, polyurethane, etc., or other similar material. In at least one preferred embodiment, the outer surface of the cover is made from faux suede.

The outer surface 22 is provided with one or more of a wide variety of textures for the purpose of improving the user's grip, and to customize the appearance and feel of a user's particular controller based on the user's personal preferences for expressing aesthetic individuality or improved gaming performance. The inner surface 21 can be smooth to ease the insertion of the video game controller.

Referring again to FIG. 1, in one preferred embodiment, optional decorative visual insignia/logos 26 and 27 are attached to or are integral to the outer surface 22 of the cover material, and may be in the form of photos, drawings, or other designed images or graphics. Such decorative indicia would allow for customization and enhanced aesthetic appeal of a user's game controller and could be located on any available surface. Examples include trademarks and company logos, sport team insignia, cartoon characters, video game competition sponsorship identification, customized graphics and the like.

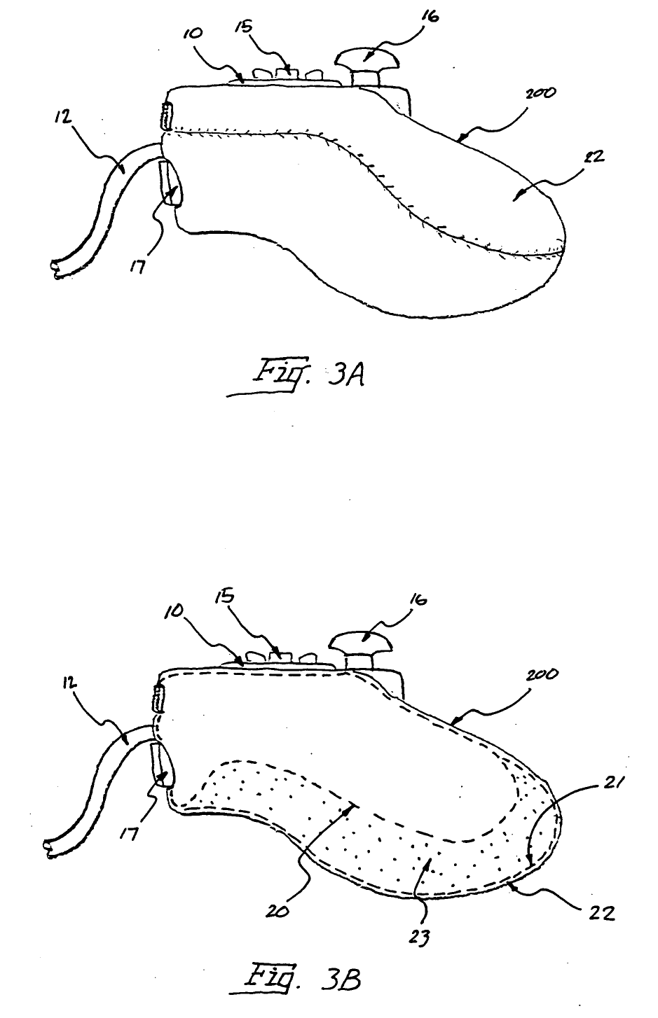

Referring again to FIGS. 2A Through 3B, padding material 23 can be of any compressible resilient matter such as gel padding, neoprene or other compressible foam, and is disposed proximate to the game controller grip members 24 and 25, such that the cover is ergonomically padded. The padding 23 being located at selected locations along the controller gripping members 24 and 25 helps to maximize a user's grip, minimize user hand muscle fatigue, and to decrease the chances of repetitive motion injury, such as carpal tunnel syndrome, with prolonged or continuous use.

In one embodiment, the padding elements 23 are affixed directly to the inner surface 21 of the cover 200. The padding elements 23 are located at precise locations to conform directly to grip locations for specific controller bodies. The cover 200 with padding is fitted onto a controller housing 20, and is secured by attachment means. In another preferred embodiment (described below) the cover is constructed from two overlapping layers of material, and the padding is placed between the layers in locations where it will be proximate to a controller grip member when a controller is inserted in the cover.

In an alternative embodiment, one or more padding elements are applied with an aggressive yet releasable adhesive directly to the gripping members of a controller housing. The cover having a glove-like body and an open end to accommodate the controller housing, is then fitted onto the padded controller housing, aligning actuator openings in the cover to actuator switches, and is secured by overlapping flaps of the cover having a securing means such as hook-and-loop fasteners (Velcro ®). The cover can also be secured to the controller body by a releasable adhesive, a series of snaps, or one or more zippers.

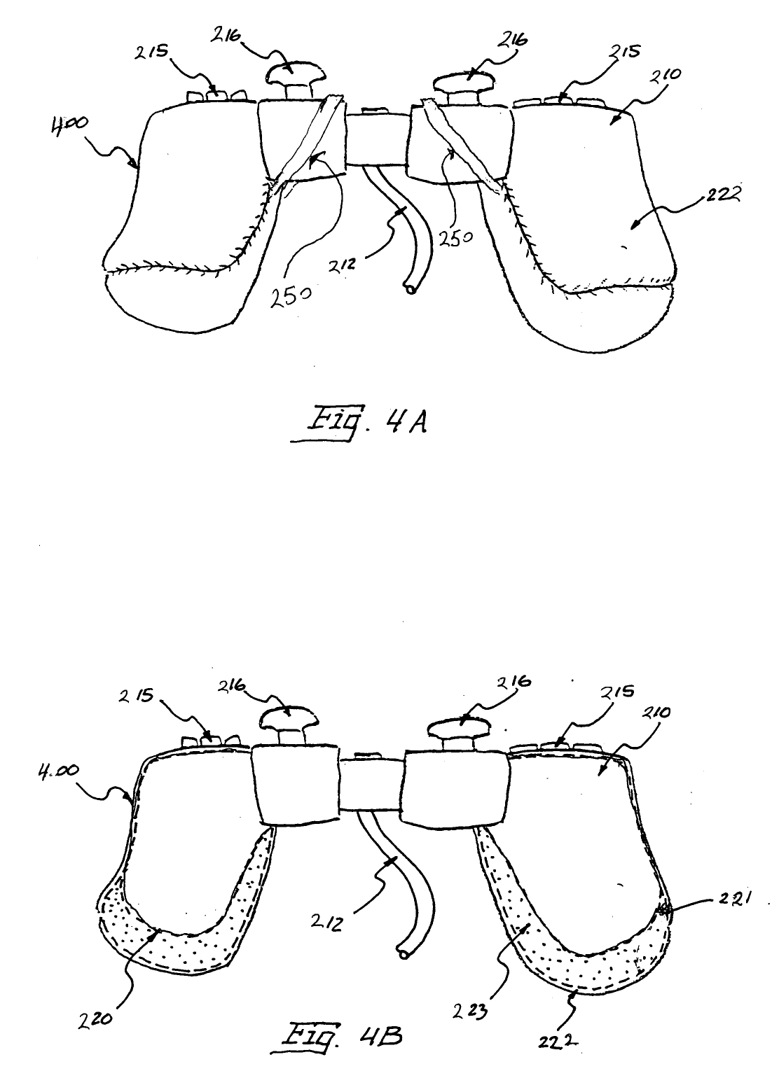

Referring now to FIGS. 4A and 4B, there is shown another preferred embodiment of the current invention. The cover 400 is constructed from two overlapping layers of soft flexible material. One side of the outer layer 260 of material forms the outer surface 222 of the cover, which can include designs 226, logos 227 or other visible insignia for decoration, advertising or other communication purposes. The cover 400 has an inner layer 270 of material, one side of which forms the inner surface 221 of the cover.

The inner surface of the cover contacts the exterior surface 220 of the controller, which is secured inside the interior cavity of the cover. The padding elements 223 secured between the inner layer 260 and outer layer 270 of material of the cover 400. The padding elements 223 are located at precise locations to conform directly to grip locations for specific controller bodies. The cover 400 with padding is fitted onto a controller housing 220, and is secured by attachment means.

As shown in FIG. 4A, one means for attachment is elastic loops 250 that are attached to the cover and routed over part of the game controller. Other embodiments can use one elastic loop routed over the cord for the controller, hook and loop type fasteners, zippers, snaps, buttons, or other fastening means for securing a game controller in the cover.

The current invention is for use with video game controllers and other control devices having a housing that is contoured to be grasped by the hands of a user. This type of video game housing has an upper surface portion and a pair of handgrip portions extending from the upper surface portion to a lower surface portion of the housing. The housings also have recessed portions disposed on opposing sides of the hand grip portions for contiguous contact with the insides of the user's hands to support the housing during use of the video game controller.

The controllers have a plurality of electronic actuators such as push buttons, switches, x-y positioning controls, touch pads and the like located on the upper surface, sides, and/or lower surface of the controller housing. The actuators interface with a video game processor unit by way of a cable directly coupled to the processor or by remote control, such as radio control or infrared coupling, to provide user commands to the processor.

The covers disclosed herein are made from a soft flexible material that has an inner surface and an outer surface. The glove like covers have an interior cavity defined by the inner surface and the cavity is shaped such that it is conformable to the exterior of a game control housing. The covers of the current invention can be ergonomically padded such that padding material will be disposed in the cover at portions of the cover that are proximate tot he grip surfaces of the controller housing.

In one preferred embodiment, the cover is made from one layer of material and the pads are affixed to the inner surface of the cover, in another embodiment, the cover is made from two layers of soft flexible material. In at least one preferred embodiment, the outer surface of the cover is textured and the cove adsorbs perspiration from the user's hands. At least one preferred embodiment of the covers disclosed herein is machine washable.

One preferred embodiment of the cover disclosed herein has a textured outer surface to enhance a user's grip and a smooth inner surface to ease the insertion of a game controller. At least one preferred embodiment of the covers disclosed herein has an outer surface made from faux suede and an inner surface made from vinyl.

To use the covers disclosed herein, a user selects a cover that is designed to conform to the particular model of video game controller that the user is using. The controller is then inserted into the insertion opening of the cover such that the video game control knobs, levers, and actuators can be accessed and used through the control openings that communicated through the cover. The cover is then secured on the game and the user can begin play. The pads and textured outer surface allow the user to maximize performance and a minimize hand muscle fatigue even during a protracted period of continuous use. Based on which embodiment of the invention is being used, the cover may adsorb perspiration from a user's hands, and the cover may be machine washable.

In compliance with the statute, the invention has been described in language more or less specific as to video game controllers. It is to be understood, however, that the invention is not limited to the specific means or features shown or described, since the means and features shown or described comprise preferred ways of putting the invention into effect. However, it will be readily apparent to those skilled in the art that the invention can be adapted to other uses as well. Therefore the invention should not be construed as being limited to video game applications. The invention is, therefore, claimed in any of its forms or modifications within the legitimate and valid scope of the appended claims, appropriately interpreted in accordance with the doctrine of equivalents.

### Industrial Applicability

The present invention has applicability to the field of hand controller devices as used on a personal computer or a dedicated video game system, and more particularly to an ergonomic and decorative padded covering for use on video game controllers. The covers are ergonomically padded and can be used on video game controllers to provide some level of user comfort that is higher than using the controller with no cover at all.

The controller covers are easily attachable and removable soft covers made of cloth, vinyl, leather, or the like. The covers are configured to conform to the size and shape of particular models of video game controllers. Openings in the surface of the covers allow for ready access to control actuators.

In one preferred embodiment, a cover is provided with padded material such as neoprene or other compressible foam in proximity to the game controller handles, and the cover is ergonomically padded to provide an improved grip, improved gaming performance and a minimization of hand muscle fatigue even during a protracted period of continuous use.

1. An accessory for a video game controller of the type used for a personal computer or a dedicated video game system, the accessory comprising:
a glove-like cover constructed from soft flexible material and having an inner surface and an outer surface;
the cover having an interior cavity defined by the inner surface of the cover and configured to accommodate the insertion of a video game controller housing therein;
the cover having attachment means to releasably secure a video game controller within the interior cavity; and
the cover having at least one controller access opening that communicated from the interior cavity to the exterior of the cover to allow access to video game controller actuation keys such that a video game controller can be used while it is secured within the interior cavity of the cover.

2. The accessory of claim 1 wherein the cover is constructed from two layers of flexible material, an inner layer, one side of which defines the inner surface of the cover, and an outer layer, one side of which defines the outer surface of the cover.

3. The accessory of claim 2 wherein a plurality of pads made from a compressible and resilient material are disposed between the inner layer and the outer layer of the cover in proximate location with grip surfaces of the video game controller.

4. The accessory of claim 1 wherein the cover is ergonomically padded to minimize hand muscle fatigue even during protracted periods of continuous use.

5. The accessory of claim 1 wherein the outer surface of the cover is textured such that a user's grip on a video game controller, that is inserted into the interior cavity of the cover, would be improved relative to the exterior surface of the video game controller.

6. The accessory of claim 1 wherein the inner surface of the cover has a smooth finish thereby allowing a video game controller to be easily inserted into the interior cavity thereof.

7. The accessory of claim I wherein the cover is made from a material that will adsorb perspiration from a user's hands and wick that perspiration away from the outer surface such that when a video game controller is inserted into the cover, a user's grip on the cover will not be degraded due to such perspiration during play of a video game.

8. The accessory of claim 1 wherein the cover can be cleaned in a standard household washing machine.

9. The accessory of claim 1, wherein the outer surface of the cover further comprises decorative designs that can be selected from the group of designs that include trademarks and company logos, sport team insignia, cartoon characters, video game competition sponsorship identification, customized graphics and the like.

10. A cover for a video game controller, the cover comprising:
an essentially 3-dimensional glove-like cover constructed from two layers of soft, flexible material, an inner layer, one side of which defines an inner surface of the cover, and an outer layer, one side of which defines the outer surface of the cover the cover being conformable to the size and shape of the exterior of a video game controller housing;
the cover having an interior cavity defined by the inner surface of the cover to accommodate a video game controller housing;
the cover having a first opening for the insertion of a video game controller into the interior cavity thereof;
the cover having attachment means to releasably secure a video game controller within the interior cavity; and
the cover having at least one controller access opening that communicated from the interior cavity to the exterior of the cover to allow access to video game controller actuation keys such that a video game controller can be used while it is secured within the interior cavity of the cover.

11. The cover of claim 10 wherein the cover is ergonomically padded in locations that are proximate with grip surfaces of the video game controller to minimize hand muscle fatigue even during protracted periods of continuous use.

12. The cover of claim 10 wherein the inner surface of the cover has a smooth finish thereby allowing a video game controller to be easily inserted into the interior cavity thereof; and,
the outer surface of the cover is textured such that a user's grip on a video game controller, that is inserted into the interior cavity of the cover, would be improved relative to the exterior surface of the video game controller.

13. The cover of claim 10 wherein the cover is made from a material that will adsorb perspiration from a user's hands and wick that perspiration away from the outer surface such that when a video game controller is inserted into the cover, a user's grip on the cover will not be degraded due to such perspiration during play of a video game.

14. The cover of claim 10 wherein the cover can be cleaned in a standard household washing machine.

15. The cover of claim 10 wherein the outer surface of the cover further comprises decorative designs that can be selected from the group of designs that include trademarks and company logos, sport team insignia, cartoon characters, video game competition sponsorship identification, customized graphics and the like.

16. A cover for a video game controller, the cover comprising:
a glove-like cover constructed from two layers of soft, flexible material, an inner layer, one side of which defines an inner surface of the cover, and an outer layer, one side of which defines the outer surface of the cover
the cover being conformable to the size and shape of the exterior of a video game controller housing;
the cover having an interior cavity defined by the inner surface of the cover to accommodate a video game controller housing;
the cover having a plurality of pads made from a compressible and resilient material disposed between the inner layer and the outer layer of the cover in proximate location with grip surfaces of the video game controller;
the cover having a first opening for the insertion of a video game controller into the interior cavity thereof;
the cover having attachment means to releasably secure a video game controller within the interior cavity;
the cover having at least one controller access opening that communicated from the interior cavity to the exterior of the cover to allow access to video game controller actuation keys such that a video game controller can be used while it is secured within the interior cavity of the cover; and
whereby the cover is ergonomically padded to minimize hand muscle fatigue even during protracted periods of continuous use.

17. The cover of claim 16 wherein the inner surface of the cover has a smooth finish thereby allowing a video game controller to be easily inserted into the interior cavity thereof; and,
the outer surface of the cover is textured such that a user's grip on a video game controller, that is inserted into the interior cavity of the cover, would be improved relative to the exterior surface of the video game controller.

18. The cover of claim 16 wherein the cover is made from a material that will adsorb perspiration from a user's hands and wick that perspiration away from the outer surface such that when a video game controller is inserted into the cover, a user's grip on the cover will not be degraded due to such perspiration during play of a video game., and the cover can be cleaned in a standard household washing machine.

19. The cover of claim 16, wherein the outer surface of the cover further comprises decorative designs that can be selected from the group of designs that include trademarks and company logos, sport team insignia, cartoon characters, video game competition sponsorship identification, customized graphics and the like.

20. The cover of claim 16, wherein the soft flexible material that comprises the outer surface of the cover is faux suede.
